(19) United States
(12) Patent Application Publication
(10) Pub. No.: US 2025/0212225 A1
(43) Pub. Date: Jun. 26, 2025

(54) TIME-DOMAIN RESOURCE BLOCK MAPPING

(71) Applicant: QUALCOMM Incorporated, San Diego, CA (US)

(72) Inventors: Wei YANG, San Diego, CA (US); Jing SUN, San Diego, CA (US); Jing JIANG, San Diego, CA (US)

(21) Appl. No.: 18/393,253

(22) Filed: Dec. 21, 2023

(51) Int. Cl. H04W 72/231; H04L 5/00; H04W 72/0446; H04W 72/0453; H04W 72/12

(52) U.S. Cl. CPC H04W 72/231; H04W 72/0446; H04W 72/0453; H04W 72/12; H04L 5/0007

(57) ABSTRACT

Methods, systems, and devices for wireless communication are described. A network entity may receive first control information that schedules reception, at the network entity, of a first message during a set of time-frequency resources. The network entity may receive second control information that is associated with a time-domain resource block (TDRB) pattern, where the TDRB pattern defines a first TDRB during at least a portion of the set of time-frequency resources and the first TDRB includes a set of orthogonal frequency-division multiplexing (OFDM) symbols. The network entity may demodulate data based on the TDRB pattern. In some examples, before demodulating the data, the network entity may receive and cache the data during the first TDRB, where the demodulation is performed for the first TDRB before caching or demodulating data for subsequent TDRBs.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). The following relates to wireless communications that pertain to resource element mapping.

### SUMMARY

The described techniques relate to improved methods, systems, devices, and apparatuses that support time-domain resource block (TDRB) mapping. For example, the described techniques provide for performing resource mapping according to a TDRB pattern. For example, a network entity may receive control information that schedules reception of a message during a set of time-frequency resources and control information associated with the TDRB pattern. In some examples, the network entity may receive an indication of the TDRB pattern, or, in some other examples, the network entity may receive an indication of definitions of starting and ending boundaries to be used to determine the TDRB pattern. In other words, the network entity may receive an indication of the TDRB pattern or an indication of how to determine the TDRB pattern. The network entity may receive, cache, and demodulate data during TDRBs defined by the TDRB pattern. For example, for a temporally first TDRB of the TDRB pattern, the network entity may receive data, cache the data, and demodulate the data. The network entity may receive, cache, and demodulate data for a temporally second TDRB of the TDRB pattern after demodulating the data for the first TDRB. That is, the network entity may cache and demodulate data on a TDRB-basis.

A method for wireless communication by a network entity is described. The method may include receiving first control information that schedules reception, at the network entity, of a first message during a set of time-frequency resources, receiving second control information that is associated with a TDRB pattern, where the TDRB pattern defines a first TDRB during at least a portion of the set of time-frequency resources, and where the first TDRB includes a set of orthogonal frequency-division multiplexing (OFDM) symbols, and demodulating data based on the TDRB pattern.

A network entity for wireless communication is described. The network entity may include a processing system configured to receive first control information that schedules reception, at the network entity, of a first message during a set of time-frequency resources, receive second control information that is associated with a TDRB pattern, where the TDRB pattern defines a first TDRB during at least a portion of the set of time-frequency resources, and where the first TDRB includes a set of OFDM symbols, and demodulate data based on the TDRB pattern.

Another network entity for wireless communication is described. The network entity may include means for receiving first control information that schedules reception, at the network entity, of a first message during a set of time-frequency resources, means for receiving second control information that is associated with a TDRB pattern, where the TDRB pattern defines a first TDRB during at least a portion of the set of time-frequency resources, and where the first TDRB includes a set of OFDM symbols, and means for demodulating data based on the TDRB pattern.

A non-transitory computer-readable medium having code for wireless communication stored thereon is described. The code may, when executed by a network entity, cause the network entity to receive first control information that schedules reception, at the network entity, of a first message during a set of time-frequency resources, receive second control information that is associated with a TDRB pattern, where the TDRB pattern defines a first TDRB during at least a portion of the set of time-frequency resources, and where the first TDRB includes a set of OFDM symbols, and demodulate data based on the TDRB pattern.

Some examples of the method, network entities, and non-transitory computer-readable medium described herein may further include operations, features, means, or instructions for receiving the data during the first TDRB and caching the data received during the first TDRB for subsequent processing.

In some examples of the method, network entities, and non-transitory computer-readable medium described herein, to demodulate the data, the network entity may be configured to demodulate the data after a temporally last OFDM symbol of the first TDRB.

Some examples of the method, network entities, and non-transitory computer-readable medium described herein may further include operations, features, means, or instructions for performing a channel estimation procedure after a temporally last OFDM symbol of the first TDRB, where the channel estimation procedure may be based on a portion of the data received during the first TDRB.

In some examples of the method, network entities, and non-transitory computer-readable medium described herein, the TDRB pattern defines a set of multiple TDRBs that includes the first TDRB, and where a codeword of the first message may be resource mapped to the first TDRB in accordance with a mapping scheme on a per TDRB basis.

In some examples of the method, network entities, and non-transitory computer-readable medium described herein, the mapping scheme may be a time-first, frequency-second mapping scheme within each of the set of multiple TDRBs.

In some examples of the method, network entities, and non-transitory computer-readable medium described herein, the mapping scheme may be a frequency-first, time-second mapping scheme within each of the set of multiple TDRBs.

In some examples of the method, network entities, and non-transitory computer-readable medium described herein, the set of multiple TDRBs includes one or more TDRBs in each of multiple subbands, and where the mapping scheme may be a frequency-first, time-second mapping scheme within each of the set of multiple TDRBs, and a subband-first, time-second mapping scheme between individual ones of the set of multiple TDRBs.

In some examples of the method, network entities, and non-transitory computer-readable medium described herein, the TDRB pattern includes the first TDRB and one or more second TDRBs that follow, in time, the first TDRB.

In some examples of the method, network entities, and non-transitory computer-readable medium described herein, the first TDRB includes one or more boundaries in time based on locations of demodulation reference signal (DMRS) symbols, where the one or more boundaries include at least one of a starting boundary in time or an ending boundary in time.

In some examples of the method, network entities, and non-transitory computer-readable medium described herein, the ending boundary may be defined by a temporally last OFDM symbol of the first TDRB being a DMRS symbol.

In some examples of the method, network entities, and non-transitory computer-readable medium described herein, the starting boundary may be defined by a temporally first OFDM symbol of the first TDRB being a DMRS symbol.

In some examples of the method, network entities, and non-transitory computer-readable medium described herein, the first TDRB and a temporally first of the one or more second TDRBs that immediately follows the first TDRB may be defined by a DMRS symbol that may be either a temporally last OFDM symbol of the first TDRB or a temporally first OFDM symbol of the temporally first of the one or more second TDRBs.

In some examples of the method, network entities, and non-transitory computer-readable medium described herein, at least one of the first TDRB or the one or more second TDRBs may be defined to include a DMRS symbol that may be a channel estimation source for one or more OFDM symbols in an adjacent TDRB of the one or more second TDRBs.

In some examples of the method, network entities, and non-transitory computer-readable medium described herein, the adjacent TDRB may be one of a temporally first or last of the one or more second TDRBs.

In some examples of the method, network entities, and non-transitory computer-readable medium described herein, one or more temporally last TDRBs of the one or more second TDRBs do not include DMRSs.

In some examples of the method, network entities, and non-transitory computer-readable medium described herein, the one or more temporally last TDRBs each include only one OFDM symbol or less than a threshold quantity of OFDM symbols.

In some examples of the method, network entities, and non-transitory computer-readable medium described herein, at least one of the first TDRB and the one or more second TDRBs includes an ending boundary, in time, that aligns with a slot boundary.

In some examples of the method, network entities, and non-transitory computer-readable medium described herein, the second control information may be indicative of a quantity of DMRSs or DMRS occasions per TDRB, a TDRB maximum duration, or a combination thereof.

In some examples of the method, network entities, and non-transitory computer-readable medium described herein, the second control information may be indicative of the TDRB pattern.

In some examples of the method, network entities, and non-transitory computer-readable medium described herein, the second control information indicates that the network entity may be to switch to or from application of the TDRB pattern.

In some examples of the method, network entities, and non-transitory computer-readable medium described herein, the second control information may be received via a radio resource control (RRC) message, a medium access control-control element (MAC-CE), a downlink control information (DCI) message, or any combination thereof.

Some examples of the method, network entities, and non-transitory computer-readable medium described herein may further include operations, features, means, or instructions for reporting channel estimation time window duration information, where the second control information may be based on the channel estimation time window duration information.

In some examples of the method, network entities, and non-transitory computer-readable medium described herein, the second control information includes a DMRS pattern or an updated TDRB pattern, or both, that may be based on channel estimation time window duration information.

A method for wireless communication by a first network entity is described. The method may include transmitting first control information that schedules reception, at a second network entity, of a first message during a set of time-frequency resources and transmitting second control information that is associated with a TDRB pattern, where the TDRB pattern defines a first TDRB during at least a portion of the set of time-frequency resources, and where the first TDRB includes a set of OFDM symbols.

A first network entity for wireless communication is described. The first network entity may include one or more memories storing processor executable code, and one or more processors coupled with the one or more memories. The one or more processors may individually or collectively operable to execute the code to cause the first network entity to transmit first control information that schedules reception, at a second network entity, of a first message during a set of time-frequency resources and transmit second control information that is associated with a TDRB pattern, where the TDRB pattern defines a first TDRB during at least a portion of the set of time-frequency resources, and where the first TDRB includes a set of OFDM symbols.

Another first network entity for wireless communication is described. The first network entity may include means for transmitting first control information that schedules reception, at a second network entity, of a first message during a set of time-frequency resources and means for transmitting second control information that is associated with a TDRB pattern, where the TDRB pattern defines a first TDRB during at least a portion of the set of time-frequency resources, and where the first TDRB includes a set of OFDM symbols.

A non-transitory computer-readable medium storing code for wireless communication is described. The code may include instructions executable by one or more processors to transmit first control information that schedules reception, at a second network entity, of a first message during a set of time-frequency resources and transmit second control information that is associated with a TDRB pattern, where the TDRB pattern defines a first TDRB during at least a portion of the set of time-frequency resources, and where the first TDRB includes a set of OFDM symbols.

In some examples of the method, first network entities, and non-transitory computer-readable medium described herein, the TDRB pattern defines a set of multiple TDRBs that includes the first TDRB, and where a codeword of the first message may be resource mapped to the first TDRB in accordance with a mapping scheme on a per TDRB basis.

In some examples of the method, first network entities, and non-transitory computer-readable medium described herein, the mapping scheme may be a time-first, frequency-second mapping scheme within each of the set of multiple TDRBs.

In some examples of the method, first network entities, and non-transitory computer-readable medium described herein, the mapping scheme may be a frequency-first, time-second mapping scheme within each of the set of multiple TDRBs.

In some examples of the method, first network entities, and non-transitory computer-readable medium described herein, the set of multiple TDRBs includes one or more TDRBs in each of multiple subbands, and where the mapping scheme may be a frequency-first, time-second mapping scheme within each of the set of multiple TDRBs, and a subband-first, time-second mapping scheme between individual ones of the set of multiple TDRBs.

In some examples of the method, first network entities, and non-transitory computer-readable medium described herein, the TDRB pattern includes the first TDRB and one or more second TDRBs that follow, in time, the first TDRB.

In some examples of the method, first network entities, and non-transitory computer-readable medium described herein, the first TDRB includes one or more boundaries in time based on locations of DMRS symbols, where the one or more boundaries include at least one of a starting boundary in time or an ending boundary in time.

In some examples of the method, first network entities, and non-transitory computer-readable medium described herein, the ending boundary may be defined by a temporally last OFDM symbol of the first TDRB being a DMRS symbol.

In some examples of the method, first network entities, and non-transitory computer-readable medium described herein, the starting boundary may be defined by a temporally first OFDM symbol of the first TDRB being a DMRS symbol.

In some examples of the method, first network entities, and non-transitory computer-readable medium described herein, the first TDRB and a temporally first of the one or more second TDRBs that immediately follows the first TDRB may be defined by a DMRS symbol that may be either a temporally last OFDM symbol of the first TDRB or a temporally first OFDM symbol of the temporally first of the one or more second TDRBs.

In some examples of the method, first network entities, and non-transitory computer-readable medium described herein, at least one of the first TDRB or the one or more second TDRBs may be defined to include a DMRS symbol that may be a channel estimation source for one or more OFDM symbols in an adjacent TDRB of the one or more second TDRBs.

In some examples of the method, first network entities, and non-transitory computer-readable medium described herein, the adjacent TDRB may be one of a temporally first or last of the one or more second TDRBs.

In some examples of the method, first network entities, and non-transitory computer-readable medium described herein, one or more temporally last TDRBs of the one or more second TDRBs do not include DMRSs.

In some examples of the method, first network entities, and non-transitory computer-readable medium described herein, the one or more temporally last TDRBs each include only one OFDM symbol or less than a threshold quantity of OFDM symbols.

In some examples of the method, first network entities, and non-transitory computer-readable medium described herein, at least one of the first TDRB and the one or more second TDRBs includes an ending boundary, in time, that aligns with a slot boundary.

In some examples of the method, first network entities, and non-transitory computer-readable medium described herein, the second control information may be indicative of a quantity of DMRSs or DMRS occasions per TDRB, a TDRB maximum duration, or a combination thereof.

In some examples of the method, first network entities, and non-transitory computer-readable medium described herein, the second control information may be indicative of the TDRB pattern.

In some examples of the method, first network entities, and non-transitory computer-readable medium described herein, the second control information indicates that the second network entity may be to switch to or from application of the TDRB pattern.

In some examples of the method, first network entities, and non-transitory computer-readable medium described herein, the second control information may be transmitted via an RRC message, a medium access control-control element (MAC-CE), a DCI message, or any combination thereof.

Some examples of the method, first network entities, and non-transitory computer-readable medium described herein may further include operations, features, means, or instructions for receiving a report including channel estimation time window duration information, where the second control information may be based on the channel estimation time window duration information.

In some examples of the method, first network entities, and non-transitory computer-readable medium described herein, the second control information includes a DMRS pattern or an updated TDRB pattern, or both, that may be based on channel estimation time window duration information.

### BRIEF DESCRIPTION OF THE DRAWINGS

FIGS. 1 and 2 show examples of wireless communication systems that support TDRB mapping in accordance with one or more aspects of the present disclosure.

FIG. 3 shows an example of TDRB pattern diagrams that support TDRB mapping in accordance with one or more aspects of the present disclosure.

FIG. 4 shows an example of a resource element mapping diagram that supports TDRB mapping in accordance with one or more aspects of the present disclosure.

FIG. 5 shows an example of a process flow that supports TDRB mapping in accordance with one or more aspects of the present disclosure.

FIGS. 6 and 7 show block diagrams of devices that support TDRB mapping in accordance with one or more aspects of the present disclosure.

FIG. 8 shows a block diagram of a communications manager that supports TDRB mapping in accordance with one or more aspects of the present disclosure.

FIG. 9 shows a diagram of a system including a device that supports TDRB mapping in accordance with one or more aspects of the present disclosure.

FIGS. 10 and 11 show flowcharts illustrating methods that support TDRB mapping in accordance with one or more aspects of the present disclosure.

### DETAILED DESCRIPTION

Wireless devices may map a data signal to resources in a frequency-first, time-second manner, where the data signal is mapped across all frequency tones of a first symbol, then across all frequency tones of a second symbol, and so on. The frequency-first, time-second mapping may enable channel estimation to be performed relatively quickly after receiving the data signal. However, the channel estimation may be performed quickly when demodulation reference signals (DMRSs) occur at the beginning of the data signal. In other words, channel estimation may be performed quickly when the DMRSs of the data signal are front-loaded. For example, a receiving device may perform demodulation after decoding a first symbol of the signal, which may include the DMRS, and subsequently perform channel estimation channel estimation. In some cases, in order for channel estimation quality to be improved, the data signal may include DMRSs at the beginning of the signal and at one or more other instances. In other words, several symbols of the data signal may include DMRSs, which may be non-contiguous in time. In such cases, the receiving device may experience latency associated with channel estimation, demodulation, or both based on waiting to decode additional symbols occurring throughout data signal before beginning channel estimation. Further, storing channel estimates across the entire frequency may be associated with high memory usage at the receiving device.

A wireless device may perform multiple rounds of channel estimation according to channel estimation windows. For example, the wireless device may break up the channel estimation into multiple groups, which may be referred to as channel estimation windows, such that the wireless device may perform demodulation after each respective group, thereby reducing latency. The channel estimation window may correspond to a time-domain resource block (TDRB), where resource mapping is performed per TDRB. That is, a transmitting device may map respective codewords of a transmission to a first TDRB, then to a second TDRB, and so on. The mapping may be time-first, frequency-second mapping within each TDRB, and, in some examples, may be according to one or more subbands. The TDRB mapping may support reduced memory usage at the receiving device, as the receiving device may store channel estimates for respective TDRBs, TDRB-subbands, or both rather than channel estimates across an entire frequency and resource block. The TDRB mapping may also support reduced latency at the receiving device when, for example, the data signal includes multiple, non-contiguous DMRSs.

Aspects of the disclosure are initially described in the context of wireless communications systems. Aspects of the disclosure are also described in the context of TDRB pattern diagrams, resource element mapping diagrams, and process flows. Aspects of the disclosure are further illustrated by and described with reference to apparatus diagrams, system diagrams, and flowcharts that relate to TDRB mapping.

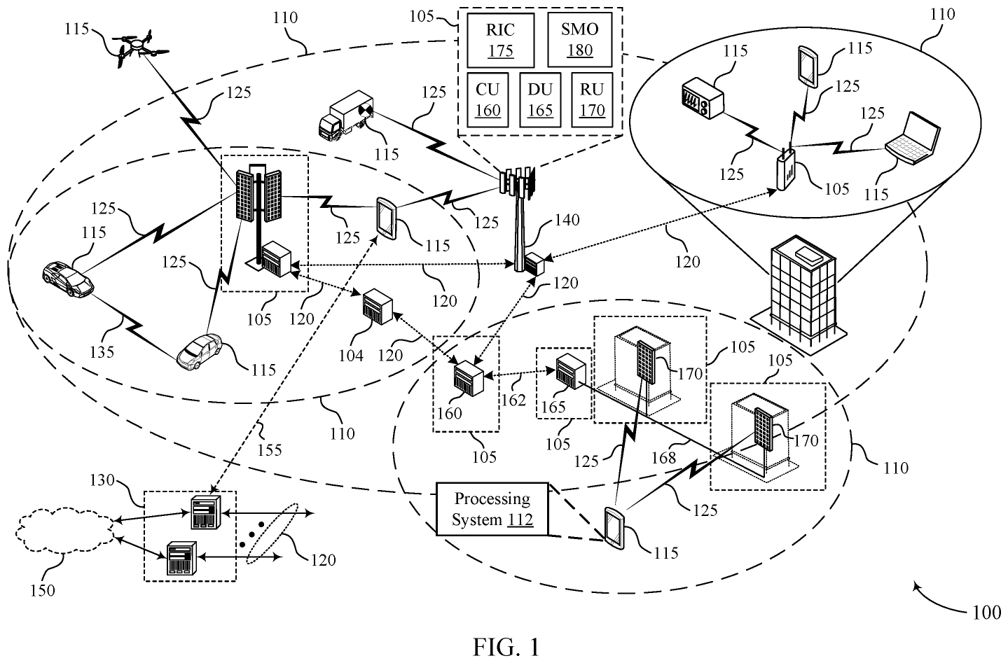

FIG. 1 shows an example of a wireless communications system 100 that supports TDRB mapping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support TDRB mapping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

As described herein, the network entity 105, the UE 115, or both may perform resource mapping according to a TDRB pattern. For example, the network entity 105 may receive control information that schedules reception of a message during a set of time-frequency resources and control information associated with the TDRB pattern. In some examples, the network entity 105 may receive an indication of the TDRB pattern (e.g., directly) or the network entity 105 may receive an indication of definitions of starting and ending boundaries to be used to determine the TDRB pattern (e.g., an indication of how to determine the TDRB pattern). The network entity 105 may receive, cache, and demodulate data during TDRBs defined by the TDRB pattern. For example, during a first TDRB (e.g., in time) of the TDRB pattern, the network entity 105 may receive data, cache the data, and demodulate the data. The network entity 105 may receive, cache, and demodulate data during a second TDRB (e.g., in time) of the TDRB pattern after demodulating the data for the first TDRB.

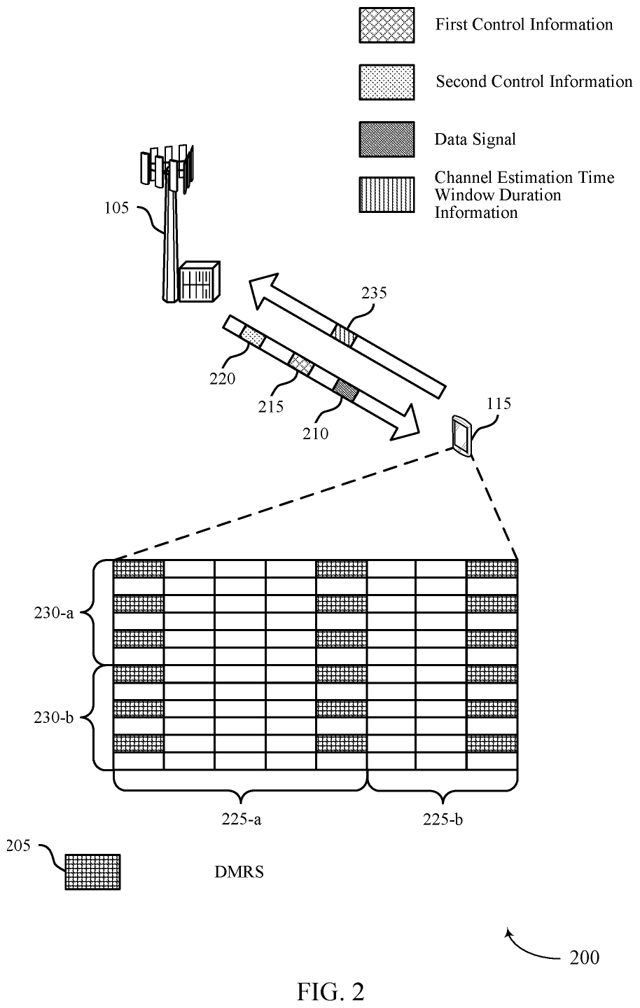

FIG. 2 shows an example of a wireless communications system 200 that supports TDRB mapping in accordance with one or more aspects of the present disclosure. The wireless communications system 200 may implement or be implemented by various aspects of the wireless communications system 100. For example, the wireless communications system 200 may include a network entity 105 and a UE 115, which may represent examples of corresponding devices as described with reference to FIG. 1.

The network entity 105 may transmit one or more data signals to the UE 115 including DMRSs 205. For example, the network entity 105 may transmit a data signal 210 via a set of time-frequency resources. One or more symbols of the time-frequency resources may include the DMRSs 205. For example, the set of time-frequency resources may include at least a first OFDM symbol where DMRSs 205 may be dispersed. That is, DMRSs 205 may be mapped to resource elements of the set of time-frequency resources according to a DMRS sequence or configuration. As an example, the DMRSs 205 in the first OFDM symbol may be dispersed to every other (e.g., every second) resource element in a frequency domain of the set of time-frequency resources. In some other examples, the DMRSs 205 in the first OFDM symbol may be dispersed to every third resource element of the frequency domain of the set of time-frequency resources. The resource elements unpopulated by DMRSs 205 in the first OFDM symbol may include data or be empty (e.g., not include a signal).

The UE 115 may use the DMRSs 205 to demodulate a signal of a physical channel and perform channel estimation. For example, the UE 115 may estimate properties associated with the physical channel (e.g., PDCCH, PDSCH, etc.) based on receiving and demodulating the data signal 210 including the DMRSs 205. In other words, the UE 115 may perform the channel estimation after receiving the DMRSs 205. However, in some examples, the data signal 210 may include more than one DMRS in the data signal 210 to improve a quality of the channel estimation by the UE 115, where the DMRSs 205 may be distributed in the set of time-frequency resources. That is, the DMRSs 205 may not be front-loaded. The UE 115 may experience increased latency (e.g., compared to the case of front-loaded DMRSs), as the UE 115 may wait until all the DMRSs 205 are received before performing channel estimation. Further, the data signal 210 including the DMRSs 205 may be associated with large memory usage at the UE 115, as the UE 115 may store channel estimates across the entire set of time-frequency resources before demodulating the data signal 210.

The network entity 105 and the UE 115 may reduce latency and memory usage at the UE 115 associated with receiving the data signal 210 by implementing TDRBs. For example, the network entity 105 may map the data signal 210 according to a TDRB pattern including respective groups of TDRBs over which the UE 115 is to cache and demodulate data (e.g., to perform channel estimation). In other words, the UE 115 may cache and demodulate the data signal 210 according to the TDRB pattern to reduce latency and memory usage associated with receiving the data signal 210 including the DMRSs 205.

For example, the network entity 105 may transmit first control information 215 to the UE 115 scheduling reception of a first message during the set of time-frequency resources. The data signal 210 may include the first message. The network entity 105 may transmit second control information 220 to the UE 115 associated with a TDRB pattern. For example, the TDRB pattern may define at least a first TDRB during at least a portion of the set of time-frequency resources. The first TDRB may correspond to a set of OFDM symbols.

The second control information 220 associated with the TDRB pattern may include the TDRB pattern itself or information associated with the TDRB pattern such that the UE 115 may identify (e.g., determine) the TDRB pattern based on the information. For example, the network entity 105 may transmit one or more signals including information for the UE 115 to determine the TDRB pattern via an RRC message, a medium access control-control element (MAC-CE) message, a downlink control information (DCI) message, or the like.

In some examples, the network entity 105 may indicate a quantity of DMRS symbols per TDRB. Additionally, or alternatively, the network entity 105 may indicate a quantity of DMRS occasions per TDRB (e.g., in the example of a double DMRS symbol). That is, the UE 115 may receive the indication of the quantity of DMRS symbols per TDRB and identify or determine the boundaries between TDRBs accordingly. Additionally, or alternatively, the network entity 105 may indicate a threshold (e.g., minimum or maximum) duration of a TDRB. For example, the UE 115 may determine the TDRB pattern to satisfy the indicated threshold duration. In some examples, the network entity 105 may indicate an TDRB pattern (e.g., an exact TDRB pattern, directly indicate, etc.). For example, the network entity 105 may indicate the TDRB pattern to be used by the UE 115 to cache and demodulate the data signal 210.

In some examples, the network entity 105 may indicate (e.g., via the second control information 220 or a separate transmission) a mapping rule. For example, the network entity 105 may indicate that the UE 115 is to use TDRB-based mapping; frequency-first, time-second mapping; subband-based mapping; or a combination. In some examples, the network entity 105 may indicate a new mapping rule which overrides a previously indicated mapping rule.

The network entity 105 may transmit the data signal 210 to the UE 115 after, for example, indicating the first control information 215, the second control information 220, or both. The UE 115 may cache (e.g., store) data for OFDM symbols of TDRBs and perform channel estimation according to the TDRBs. In other words, the UE 115 may cache data and perform channel estimation based on receiving the first control information and the second control information. As an example, the UE 115 may cache data of a first set of OFDM symbols of a first TDRB 225-a and perform channel estimation according to the DMRSs 205 in the first TDRB 225-a. After performing the channel estimation for the first TDRB 225-a, the UE 115 may cache data of a second set of OFDM symbols of a second TDRB 225-b and perform channel estimation according to the DMRSs 205 in the second TDRB 225-b. For example, the first TDRB 225-a may occur before the second TDRB 225-b in time.

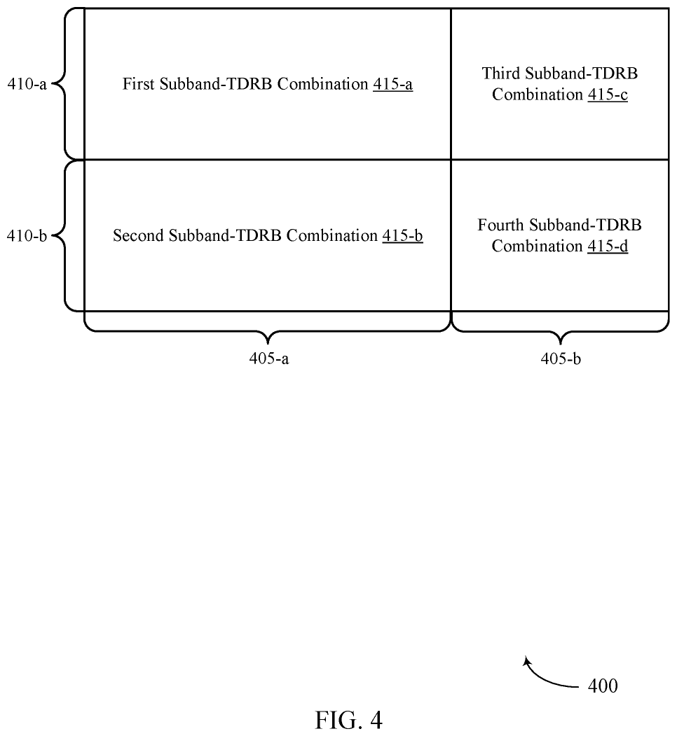

In some examples, the UE 115 may, within the first TDRB 225-a, the second TDRB 225-b, or both, decode the data according to a time-first, frequency-second mapping scheme. In some other examples, the UE 115 may decode the data within the first TDRB 225-a, the second TDRB 225-b, or both according to a subband-first, time-second mapping scheme. That is, the UE 115 may decode the data first across subbands of the set of frequency resources within TDRBs, then across TDRBs of the set of time resources. For example, the UE 115 may decode the data across a first subband 230-a and the first TDRB 225-a, across a second subband 230-b and the first TDRB 225-a, the first subband 230-a and the second TDRB 225-b, and, lastly, the second subband 230-b and the second TDRB 225-b. The subband and TDRB-based mapping may be described in further detail elsewhere herein, including with reference to FIG. 4. The subband-based mapping may reduce memory usage at the UE 115 (e.g., compared to mapping across an entire frequency band). For example, the UE 115 may cache data for subband-TDRB combinations.

The UE 115 may report channel estimation time window duration information 235 to the network entity 105. For example, the UE 115 may report the channel estimation time window duration information 235 based on performing the channel estimation after receiving the data signal 210 or prior to receiving the second control information 220. The channel estimation time window duration information 235 may include a request from the UE 115 to shorten or lengthen a channel estimation time window duration based on receiving the data signal 210 and performing the channel estimation. As an example, the UE 115 may report that the channel estimation time window durations (e.g., the symbol length of the TDRBs) are too long and request shorter durations to reduce latency. Or, the UE 115 may request a channel estimation time window duration prior to receiving the second control information 220 to meet a threshold latency. The network entity 105 may transmit the second control information 220 based on receiving the channel estimation time window duration information 235 or, in some other examples, adjust the DMRS pattern, the TDRB pattern, or both used for downlink transmissions.

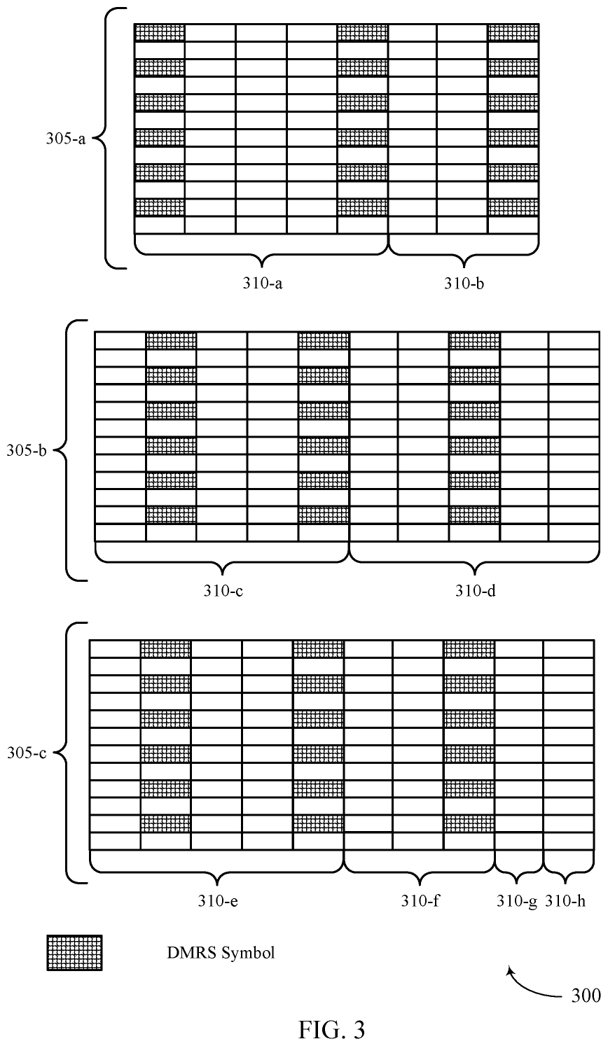

FIG. 3 shows an example of TDRB pattern diagrams 300 that supports TDRB mapping in accordance with one or more aspects of the present disclosure. The TDRB pattern diagrams 300 may implement or be implemented by various aspects of the wireless communications system 100, the wireless communications system 200, or both. For example, the TDRB pattern diagrams 300 may be implemented by a wireless device such as a network entity 105 or a UE 115, which may represent examples of corresponding devices as described with reference to FIG. 1 and FIG. 2.

A network entity or a UE may perform multiple rounds of channel estimation according to multiple channel estimation windows. The channel estimation windows may correspond to respective TDRBs, where each TDRB includes a set of OFDM symbols. In some examples, the network entity or the UE may determine the TDRB pattern. That is, the network entity or the UE may determine, on a set of time-frequency resources, boundaries between respective TDRBs. In some examples, the boundaries between the respective TDRBs may be based on locations of DMRS symbols within the set of time-frequency resources. For example, the network entity may indicate a set of rules to be used by the UE to determine the TDRB pattern, or, in some other examples, the network entity may determine the TDRB pattern based on the set of rules and indicate the TDRB pattern to the UE. The following examples of TDRB patterns may represent TDRB patterns determined or identified by the network entity or the UE.

In the examples of the TDRB pattern diagrams 300, the TDRB patterns may be determined (e.g., by the network entity or UE) according to locations of DMRSs within the set of time-frequency resources. For example, a first TDRB pattern 305-a may include a TDRB 310-a and a TDRB 310-b. A boundary between the TDRB 310-a and the TDRB 310-b may be defined by a last DMRS symbol of the TDRB 310-a. For example, the boundary may be an ending boundary for the TDRB 310-a. In some other examples, a boundary DMRS symbol (e.g., the last DMRS symbol of the TDRB 310-a in the previous example) may be defined as a starting boundary for the TDRB 310-b. That is, the TDRB 310-a may include the boundary DMRS symbol. In other words, the boundary between the TDRB 310-a and the TDRB 310-b may be defined by a DMRS symbol, where the DMRS symbol may be included in the TDRB 310-a (e.g., as shown in the example of the first TDRB pattern 305-a) or the TDRB 310-b.

A second TDRB pattern 305-b may include a TDRB 310-c and a TDRB 310-d. In the example of the second TDRB pattern 305-b, the TDRB 310-c and the TDRB 310-d may include resource blocks adjacent to first DMRS symbols, last DMRS symbols, or both. For example, the TDRB 310-c may include resource blocks adjacent to the first DMRS symbol of the TDRB 310-c. Additionally, or alternatively, the TDRB 310-d may include resource blocks adjacent to the last DMRS symbol of the TDRB 310-d. In other words, a first TDRB and a last TDRB of the set of time-frequency resources may include adjacent resource blocks at the beginning or end of the TDRB.

A third TDRB pattern 305-c may include a TDRB 310-e, a TDRB 310-f, a TDRB 310-g, and a TDRB 310-h. In the example of the third TDRB pattern 305-c, the resource blocks adjacent to a last DMRS symbol of a last TDRB including DMRSs may form individual TDRBs. That is, rather than being included in an adjacent TDRB, the resource blocks after the last DMRS symbol of the TDRB 310-f may form the TDRB 310-g and the TDRB 310-h. In some examples, the resource blocks after the last DMRS symbol of the TDRB 310-f may form the TDRBs per OFDM symbol, or, in some other examples, per a threshold quantity of OFDM symbols. For example, the TDRB 310-g or the TDRB 310-h may include a quantity of OFDM symbols below a threshold quantity of OFDM symbols.

In the example of the third TDRB pattern 305-c, the TDRB 310-e may include the adjacent resource blocks before the first DMRS symbol. In other words, the third TDRB pattern 305-c may include grouping for adjacent resource blocks prior to the first DMRS symbol without grouping for adjacent resource blocks after the last DMRS symbol. In some examples, the third TDRB pattern 305-c may support receive pipelining compared to, for example, the second TDRB pattern 305-b. Additionally, or alternatively, the third TDRB pattern 305-c may allow a wireless device to fall back to a frequency-first, time-second resource mapping in the case of front-loaded DMRSs.

While not explicitly shown in the example of the TDRB pattern diagrams 400, a TDRB pattern may include a first TDRB and a second TDRB having a boundary defined by a slot boundary. That is, the first TDRB may end at an end of a first slot, and the second TDRB may start at the beginning of a second slot. For example, the set of time-frequency resources may occur across a slot boundary (e.g., in the case of a long SLIV).

FIG. 4 shows an example of a resource element mapping diagram 400 that supports TDRB mapping in accordance with one or more aspects of the present disclosure. The resource element mapping diagram 400 may implement or be implemented by various aspects of the wireless communications system 100, the wireless communications system 200, or both. For example, the resource element mapping diagram 400 may be implemented by a wireless device such as a network entity 105 or a UE 115, which may represent examples of corresponding devices as described with reference to FIG. 1 and FIG. 2.

A network entity or a UE may perform multiple rounds of channel estimation according to multiple channel estimation windows. The channel estimation windows may correspond to respective TDRBs, where each TDRB includes a set of OFDM symbols. In some examples, the network entity or the UE may determine the TDRB pattern. That is, the network entity or the UE may determine, on a set of time-frequency resources, boundaries between respective TDRBs. In some examples, the set of time-frequency resources may be further divided by splitting the frequency resources into two or more subbands. That is, the UE may decode a transmission for a given subband, and, in some examples, a subband-TDRB combination.

For example, a UE may decode a data signal within respective TDRBs according to a subband-first, time-second mapping scheme. That is, the UE may decode the data first across subbands of the set of frequency resources within TDRBs, then across TDRBs of the set of time resources. In other words, the TDRBs and subbands may form subband-TDRB combinations (e.g., portions of the time-frequency resources) which the UE individually decodes, caches, and performs channel estimation according to. In the example of FIG. 4, the set of time-frequency resources may include a first TDRB 405-a and a second TDRB 405-b in the time domain and a first subband 410-a and a second subband 410-b in the frequency domain. While two TDRBs and two subbands are shown in the example of FIG. 4, it may be understood that more or less than two TDRBs or subbands may be implemented. Respective pairings of TDRBs and subbands may form the subband-TDRB combinations. As an example, the combination of the first TDRB 405-a and the first subband 410-a may form a first subband-TDRB combination 415-a.

The UE (e.g., a receiving device) may decode the data for each subband-TDRB combination in a subband-first, TDRB-second order. For example, the UE may decode the data in the first subband-TDRB combination 415-a for a portion of a first OFDM symbol across the first subband 230-a, for a portion of a second OFDM symbol across the first subband 230-a, and so on for each OFDM symbol in the first TDRB 405-a. In other words, the UE may decode the data in a frequency-first, time-second manner within each subband-TDRB combination.

After decoding the data for the first subband-TDRB combination 415-a, the UE may decode the data for a second subband-TDRB combination 415-b formed by the second subband 410-b and the first TDRB 405-a. That is, the UE may decode data for a subsequent subband for the first TDRB 405-a before decoding data for the second TDRB 405-b. For example, after decoding the data for the second subband-TDRB combination 415-b, the UE may decode the data for a third subband-TDRB combination 415-c formed by the first subband 410-a and the second TDRB 405-b and a fourth subband-TDRB combination 415-d formed by the second subband 410-b and the second TDRB 405-b.

Additionally, or alternatively, the network entity (e.g., a transmitting device) may map the data for each subband-TDRB combination in a subband-first, TDRB-second order. For example, the network entity may map the data in the first subband-TDRB combination 415-a for a portion of a first OFDM symbol across the first subband 230-a, for a portion of a second OFDM symbol across the first subband 230-a, and so on for each OFDM symbol in the first TDRB 405-a. In other words, the network entity may map the data in a frequency-first, time-second manner within each subband-TDRB combination.

After mapping the data for the first subband-TDRB combination 415-a, the network entity may map the data for a second subband-TDRB combination 415-b formed by the second subband 410-b and the first TDRB 405-a. That is, the network entity may map data for a subsequent subband for the first TDRB 405-a before decoding data for the second TDRB 405-b. For example, after mapping the data for the second subband-TDRB combination 415-b, the network entity may map the data for a third subband-TDRB combination 415-c formed by the first subband 410-a and the second TDRB 405-b and a fourth subband-TDRB combination 415-d formed by the second subband 410-b and the second TDRB 405-b.

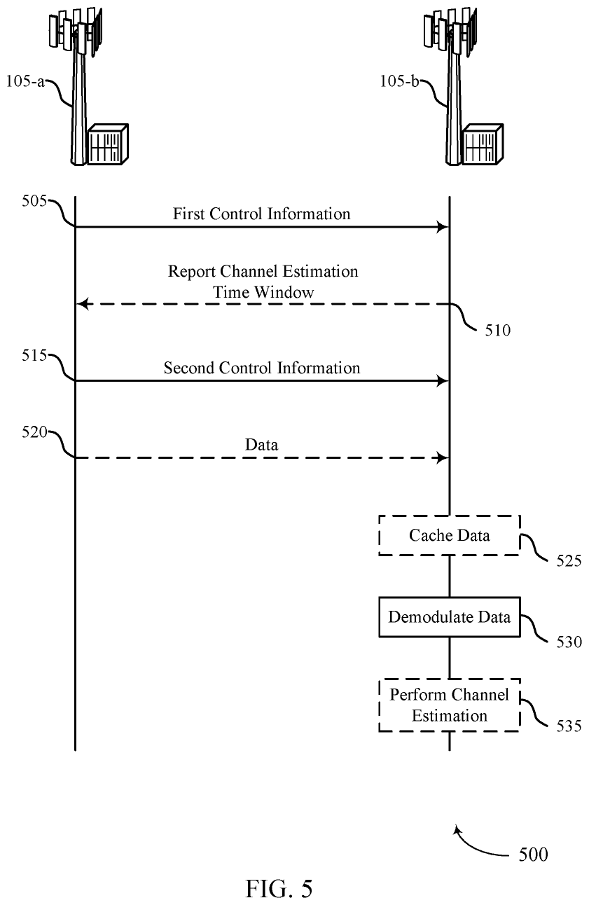

FIG. 5 shows an example of a process flow 500 that supports TDRB mapping in accordance with one or more aspects of the present disclosure. In some examples, the process flow 500 may implement or be implemented by aspects of the wireless communications system 100 or the wireless communications system 200 as described with reference to FIG. 1 or FIG. 2. For example, the process flow 500 may be implemented by a network entity 105-a and a network entity 105-b, which may be examples of the network entity 105 as described with reference to FIG. 1 and FIG. 2. The process flow 500 may also implement or be implemented by aspects of the TDRB pattern diagrams 300, the resource element mapping diagram 400, or both. Alternative examples of the following may be implemented, where some steps are performed in a different order than described or are not performed at all. In some cases, steps may include additional features not mentioned below, or further steps may be added.

At 505, the network entity 105-b may receive first control information that schedules reception, at the network entity 105-b, of a first message during a set of time-frequency resources. For example, the first control information may schedule reception of a data signal, such as the data signal 210 as described with reference to FIG. 2.

At 510, the network entity 105-b may report channel estimation time window duration information. For example, the channel estimation time window duration information may include information about a channel estimation time window length. For example, the network entity 105-b may report the channel estimation time window duration information 225 as described with reference to FIG. 2.

At 515, the network entity 105-b may receive second control information that is associated with a TDRB pattern. In some examples, the network entity 105-a may transmit the second control information via a RRC message, a MAC-CE, a DCI message, or the like. The TDRB pattern may define (e.g., at least) a first TDRB during at least a portion of the set of time-frequency resources. The first TDRB may include a set of OFDM symbols. In some examples, the second control information may be based on the channel estimation time window duration information received by the network entity 105-a at 510. For example, the second control information may include a DMRS pattern, an updated TDRB pattern, or both, based on the channel estimation time window duration information.

The TDRB pattern may define multiple TDRBs that include the first TDRB, where a codeword of the first message is resource mapped to the first TDRB in accordance with a mapping scheme on a per TDRB basis. In some examples, the mapping scheme may be a time-first, frequency-second mapping scheme within each of the multiple TDRBs. In some other examples, the mapping scheme may be a frequency-first, time-second mapping scheme within each of the multiple TDRBs. Additionally, or alternatively, the multiple TDRBs may include one or more TDRBs in each of multiple subbands. For example, the mapping scheme may be a frequency-first, time-second mapping scheme within each of the multiple TDRBs, and a subband-first, time-second mapping scheme between individual ones of the multiple TDRBs. That is, the mapping scheme may be an example of the resource element mapping diagram 400 as described with reference to FIG. 4.

In some examples, the TDRB pattern may include the first TDRB and one or more second TDRBs that follow, in time, the first TDRB. That is, the TDRB pattern may include multiple TDRBs, where some of the TDRBs follow the first TDRB temporally. The first TDRB may include one or more boundaries in time based on locations of DMRS symbols, where the one or more boundaries include a starting boundary in time, an ending boundary in time, or both. For example, the ending boundary may be defined by a temporally last OFDM symbol of the first TDRB being a DMRS symbol. Additionally, or alternatively, the starting boundary may be defined by a temporally first OFDM symbol of the first TDRB being a DMRS symbol.

In some examples, the first TDRB and a temporally first of the one or more second TDRBs that immediately follow the first TDRB may be defined by a DMRS symbol that is either a temporally last OFDM symbol of the first TDRB or a temporally first OFDM symbol of the temporally first of the one or more second TDRBs. Additionally, or alternatively, at least one of the first TDRB or the one or more second TDRBs may be defined to include a DMRS symbol that is a channel estimation source for one or more OFDM symbols in an adjacent TDRB of the one or more second time-TDRBs. For example, the adjacent TDRB may be one of a temporally first or last TDRB of the one or more second TDRBs.

In some examples, one or more temporally last TDRBs of the one or more second TDRBs may not include DMRSs. For example, after a last DMRS, the TDRB pattern may include a single TDRB per OFDM symbol or a small quantity of OFDM symbols. In other words, the one or more temporally last TDRBs may each include only one OFDM symbol or less than a threshold quantity of OFDM symbols.

Additionally, or alternatively, at least one of the first TDRB and the one or more second TDRBs may include an ending boundary, in time, that aligns with a slot boundary. For example, the first TDRB may stop at the slot boundary in a case when a transmission crosses the slot boundary (e.g., in case of long SLIV).

In some examples, the second control information may indicate a quantity of DMRSs or DMRS occasions per TDRB, a TDRB maximum duration, or both. Additionally, or alternatively, the second control information may indicate the TDRB pattern (e.g., an exact TDRB pattern).

The second control information may indicate that the network entity 105-b is to switch to or from application of the TDRB pattern. For example, the second control information may indicate that the network entity 105-b is to switch between a TDRB-based mapping and another mapping rule (e.g., frequency-first, time-second, subband-based mapping, etc.).

At 520, the network entity 105-b may receive data during the first TDRB. As the network entity 105-b receives the data (e.g., simultaneously or immediately after receiving the data), at 525, the network entity 105-b may cache the data received at 520 during the first TDRB for subsequent processing.

At 530, the network entity 105-b may demodulate the data. For example, the network entity 105-b may demodulate the data based on the TDRB pattern. In some examples, the network entity 105-b may demodulate the data after a temporally last OFDM symbol of the first TDRB.

At 535, the network entity 105-b may perform a channel estimation procedure after a temporally last OFDM symbol of the first TDRB, where the channel estimation procedure is based on a portion of the data received during the first TDRB.

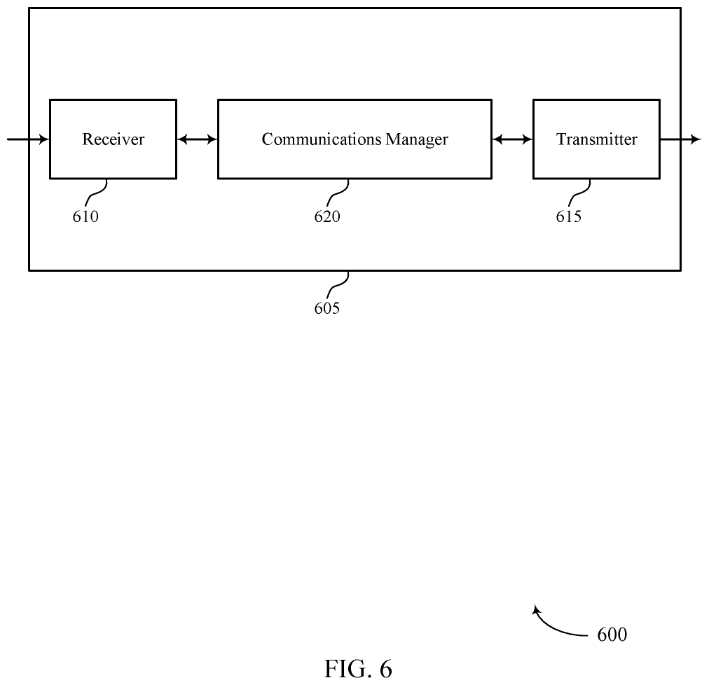

FIG. 6 shows a block diagram 600 of a device 605 that supports TDRB mapping in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of TDRB mapping as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving first control information that schedules reception, at the network entity, of a first message during a set of time-frequency resources. The communications manager 620 is capable of, configured to, or operable to support a means for receiving second control information that is associated with a TDRB pattern, where the TDRB pattern defines a first TDRB during at least a portion of the set of time-frequency resources, and where the first TDRB includes a set of OFDM symbols. The communications manager 620 is capable of, configured to, or operable to support a means for demodulating data based on the TDRB pattern.

Additionally, or alternatively, the communications manager 620 may support wireless communication in accordance with examples as disclosed herein. For example, the communications manager 620 is capable of, configured to, or operable to support a means for transmitting first control information that schedules reception, at a second network entity, of a first message during a set of time-frequency resources. The communications manager 620 is capable of, configured to, or operable to support a means for transmitting second control information that is associated with a TDRB pattern, where the TDRB pattern defines a first TDRB during at least a portion of the set of time-frequency resources, and where the first TDRB includes a set of OFDM symbols.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

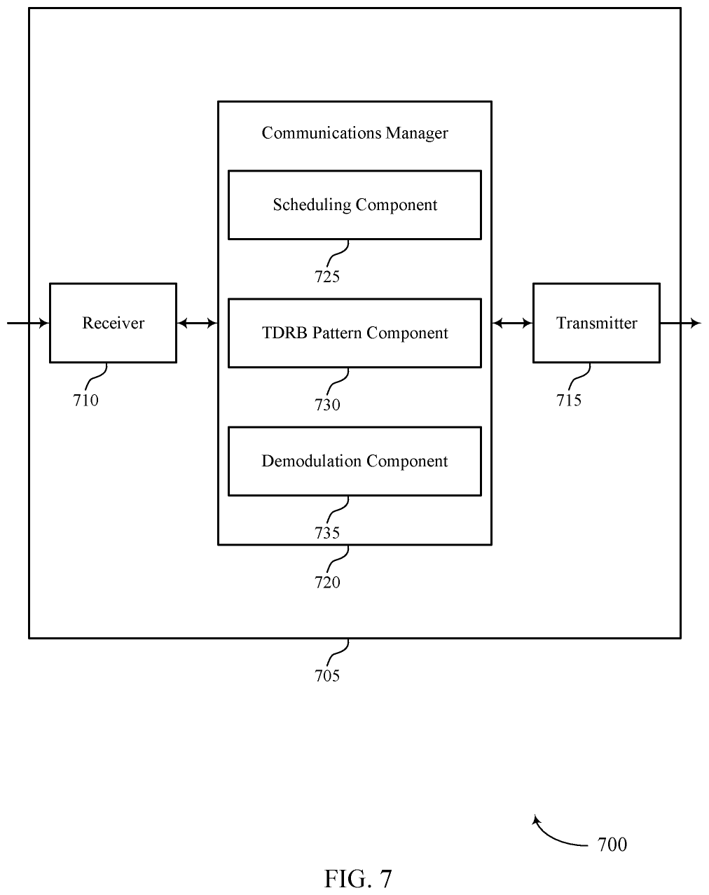

FIG. 7 shows a block diagram 700 of a device 705 that supports TDRB mapping in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of TDRB mapping as described herein. For example, the communications manager 720 may include a scheduling component 725, an TDRB pattern component 730, a demodulation component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The scheduling component 725 is capable of, configured to, or operable to support a means for receiving first control information that schedules reception, at the network entity, of a first message during a set of time-frequency resources. The TDRB pattern component 730 is capable of, configured to, or operable to support a means for receiving second control information that is associated with a TDRB pattern, where the TDRB pattern defines a first TDRB during at least a portion of the set of time-frequency resources, and where the first TDRB includes a set of OFDM symbols. The demodulation component 735 is capable of, configured to, or operable to support a means for demodulating data based on the TDRB pattern.

Additionally, or alternatively, the communications manager 720 may support wireless communication in accordance with examples as disclosed herein. The scheduling component 725 is capable of, configured to, or operable to support a means for transmitting first control information that schedules reception, at a second network entity, of a first message during a set of time-frequency resources. The TDRB pattern component 730 is capable of, configured to, or operable to support a means for transmitting second control information that is associated with a TDRB pattern, where the TDRB pattern defines a first TDRB during at least a portion of the set of time-frequency resources, and where the first TDRB includes a set of OFDM symbols.

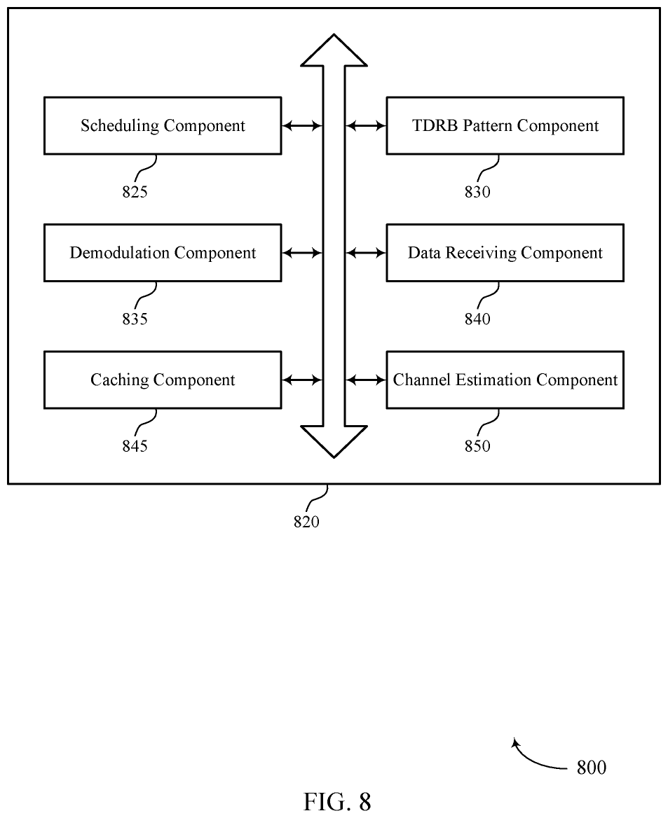

FIG. 8 shows a block diagram 800 of a communications manager 820 that supports TDRB mapping in accordance with one or more aspects of the present disclosure. The communications manager 820 may be an example of aspects of a communications manager 620, a communications manager 720, or both, as described herein. The communications manager 820, or various components thereof, may be an example of means for performing various aspects of TDRB mapping as described herein. For example, the communications manager 820 may include a scheduling component 825, an TDRB pattern component 830, a demodulation component 835, a data receiving component 840, a caching component 845, a channel estimation component 850, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication in accordance with examples as disclosed herein. The scheduling component 825 is capable of, configured to, or operable to support a means for receiving first control information that schedules reception, at the network entity, of a first message during a set of time-frequency resources. The TDRB pattern component 830 is capable of, configured to, or operable to support a means for receiving second control information that is associated with a TDRB pattern, where the TDRB pattern defines a first TDRB during at least a portion of the set of time-frequency resources, and where the first TDRB includes a set of OFDM symbols. The demodulation component 835 is capable of, configured to, or operable to support a means for demodulating data based on the TDRB pattern.

In some examples, the data receiving component 840 is capable of, configured to, or operable to support a means for receiving the data during the first TDRB. In some examples, the caching component 845 is capable of, configured to, or operable to support a means for caching the data received during the first TDRB for subsequent processing.

In some examples, to demodulate the data, the network entity is configured to demodulate the data after a temporally last OFDM symbol of the first TDRB.

In some examples, the channel estimation component 850 is capable of, configured to, or operable to support a means for performing a channel estimation procedure after a temporally last OFDM symbol of the first TDRB, where the channel estimation procedure is based on a portion of the data received during the first TDRB.

In some examples, the TDRB pattern defines a set of multiple TDRBs that includes the first TDRB, and where a codeword of the first message is resource mapped to the first TDRB in accordance with a mapping scheme on a per TDRB basis.

In some examples, the mapping scheme is a time-first, frequency-second mapping scheme within each of the set of multiple TDRBs.

In some examples, the mapping scheme is a frequency-first, time-second mapping scheme within each of the set of multiple TDRBs.

In some examples, the set of multiple TDRBs includes one or more TDRBs in each of multiple subbands, and where the mapping scheme is a frequency-first, time-second mapping scheme within each of the set of multiple TDRBs, and a subband-first, time-second mapping scheme between individual ones of the set of multiple TDRBs.

In some examples, the TDRB pattern includes the first TDRB and one or more second TDRBs that follow, in time, the first TDRB.

In some examples, the first TDRB includes one or more boundaries in time based on locations of DMRS symbols, where the one or more boundaries include at least one of a starting boundary in time or an ending boundary in time.

In some examples, the ending boundary is defined by a temporally last OFDM symbol of the first TDRB being a DMRS symbol.

In some examples, the starting boundary is defined by a temporally first OFDM symbol of the first TDRB being a DMRS symbol.

In some examples, the first TDRB and a temporally first of the one or more second TDRBs that immediately follows the first TDRB are defined by a DMRS symbol that is either a temporally last OFDM symbol of the first TDRB or a temporally first OFDM symbol of the temporally first of the one or more second TDRBs.

In some examples, at least one of the first TDRB or the one or more second TDRBs is defined to include a DMRS symbol that is a channel estimation source for one or more OFDM symbols in an adjacent TDRB of the one or more second TDRBs.

In some examples, the adjacent TDRB is one of a temporally first or last of the one or more second TDRBs.

In some examples, one or more temporally last TDRBs of the one or more second TDRBs do not include DMRSs.

In some examples, the one or more temporally last TDRBs each include only one OFDM symbol or less than a threshold quantity of OFDM symbols.

In some examples, at least one of the first TDRB and the one or more second TDRBs includes an ending boundary, in time, that aligns with a slot boundary.

In some examples, the second control information is indicative of a quantity of DMRSs or DMRS occasions per TDRB, a TDRB maximum duration, or a combination thereof.

In some examples, the second control information is indicative of the TDRB pattern.

In some examples, the second control information indicates that the network entity is to switch to or from application of the TDRB pattern.

In some examples, the second control information is received via an RRC message, a MAC-CE, a DCI message, or any combination thereof.

In some examples, the channel estimation component 850 is capable of, configured to, or operable to support a means for reporting channel estimation time window duration information, where the second control information is based on the channel estimation time window duration information.

In some examples, the second control information includes a DMRS pattern or an updated TDRB pattern, or both, that is based on channel estimation time window duration information.

Additionally, or alternatively, the communications manager 820 may support wireless communication in accordance with examples as disclosed herein. In some examples, the scheduling component 825 is capable of, configured to, or operable to support a means for transmitting first control information that schedules reception, at a second network entity, of a first message during a set of time-frequency resources. In some examples, the TDRB pattern component 830 is capable of, configured to, or operable to support a means for transmitting second control information that is associated with a TDRB pattern, where the TDRB pattern defines a first TDRB during at least a portion of the set of time-frequency resources, and where the first TDRB includes a set of OFDM symbols.

In some examples, the TDRB pattern defines a set of multiple TDRBs that includes the first TDRB, and where a codeword of the first message is resource mapped to the first TDRB in accordance with a mapping scheme on a per TDRB basis.

In some examples, the mapping scheme is a time-first, frequency-second mapping scheme within each of the set of multiple TDRBs.

In some examples, the mapping scheme is a frequency-first, time-second mapping scheme within each of the set of multiple TDRBs.

In some examples, the set of multiple TDRBs includes one or more TDRBs in each of multiple subbands, and where the mapping scheme is a frequency-first, time-second mapping scheme within each of the set of multiple TDRBs, and a subband-first, time-second mapping scheme between individual ones of the set of multiple TDRBs.

In some examples, the TDRB pattern includes the first TDRB and one or more second TDRBs that follow, in time, the first TDRB.

In some examples, the first TDRB includes one or more boundaries in time based on locations of DMRS symbols, where the one or more boundaries include at least one of a starting boundary in time or an ending boundary in time.

In some examples, the ending boundary is defined by a temporally last OFDM symbol of the first TDRB being a DMRS symbol.

In some examples, the starting boundary is defined by a temporally first OFDM symbol of the first TDRB being a DMRS symbol.

In some examples, the first TDRB and a temporally first of the one or more second TDRBs that immediately follows the first TDRB are defined by a DMRS symbol that is either a temporally last OFDM symbol of the first TDRB or a temporally first OFDM symbol of the temporally first of the one or more second TDRBs.

In some examples, at least one of the first TDRB or the one or more second TDRBs is defined to include a DMRS symbol that is a channel estimation source for one or more OFDM symbols in an adjacent TDRB of the one or more second TDRBs.

In some examples, the adjacent TDRB is one of a temporally first or last of the one or more second TDRBs.

In some examples, one or more temporally last TDRBs of the one or more second TDRBs do not include DMRSs.

In some examples, the one or more temporally last TDRBs each include only one OFDM symbol or less than a threshold quantity of OFDM symbols.

In some examples, at least one of the first TDRB and the one or more second TDRBs includes an ending boundary, in time, that aligns with a slot boundary.

In some examples, the second control information is indicative of a quantity of DMRSs or DMRS occasions per TDRB, a TDRB maximum duration, or a combination thereof.

In some examples, the second control information is indicative of the TDRB pattern.

In some examples, the second control information indicates that the second network entity is to switch to or from application of the TDRB pattern.

In some examples, the second control information is transmitted via an RRC message, a medium access control-control element (MAC-CE), a DCI message, or any combination thereof.

In some examples, the channel estimation component 850 is capable of, configured to, or operable to support a means for receiving a report including channel estimation time window duration information, where the second control information is based on the channel estimation time window duration information.

In some examples, the second control information includes a DMRS pattern or an updated TDRB pattern, or both, that is based on channel estimation time window duration information.

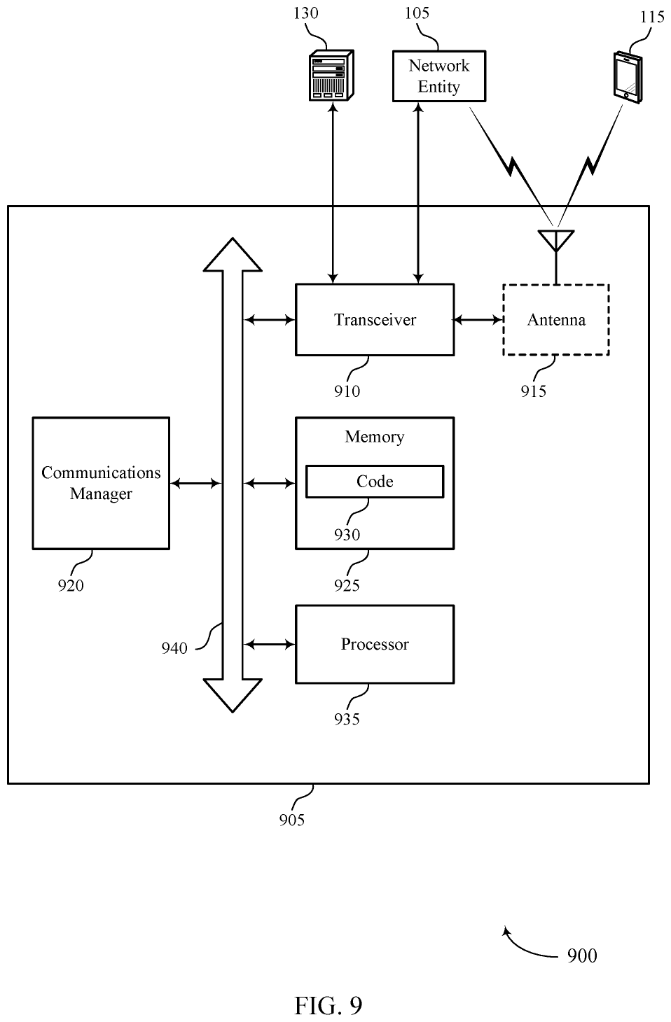

FIG. 9 shows a diagram of a system 900 including a device 905 that supports TDRB mapping in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., a communication link 125, a backhaul communication link 120, a midhaul communication link 162, a fronthaul communication link 168).

The at least one memory 925 may include RAM, ROM, or any combination thereof. The at least one memory 925 may store computer-readable, computer-executable code 930 including instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may contain, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting TDRB mapping). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925). In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communication in accordance with examples as disclosed herein. For example, the communications manager 920 is capable of, configured to, or operable to support a means for receiving first control information that schedules reception, at the network entity, of a first message during a set of time-frequency resources. The communications manager 920 is capable of, configured to, or operable to support a means for receiving second control information that is associated with a TDRB pattern, where the TDRB pattern defines a first TDRB during at least a portion of the set of time-frequency resources, and where the first TDRB includes a set of OFDM symbols. The communications manager 920 is capable of, configured to, or operable to support a means for demodulating data based on the TDRB pattern.

Additionally, or alternatively, the communications manager 920 may support wireless communication in accordance with examples as disclosed herein. For example, the communications manager 920 is capable of, configured to, or operable to support a means for transmitting first control information that schedules reception, at a second network entity, of a first message during a set of time-frequency resources. The communications manager 920 is capable of, configured to, or operable to support a means for transmitting second control information that is associated with a TDRB pattern, where the TDRB pattern defines a first TDRB during at least a portion of the set of time-frequency resources, and where the first TDRB includes a set of OFDM symbols.

By including or configuring the communications manager 920 in accordance with examples as described herein, the device 905 may support techniques for reduced latency, more efficient utilization of communication resources, and improved utilization of processing capability.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of TDRB mapping as described herein, or the at least one processor 935 and the at least one memory 925 may be otherwise configured to, individually or collectively, perform or support such operations.

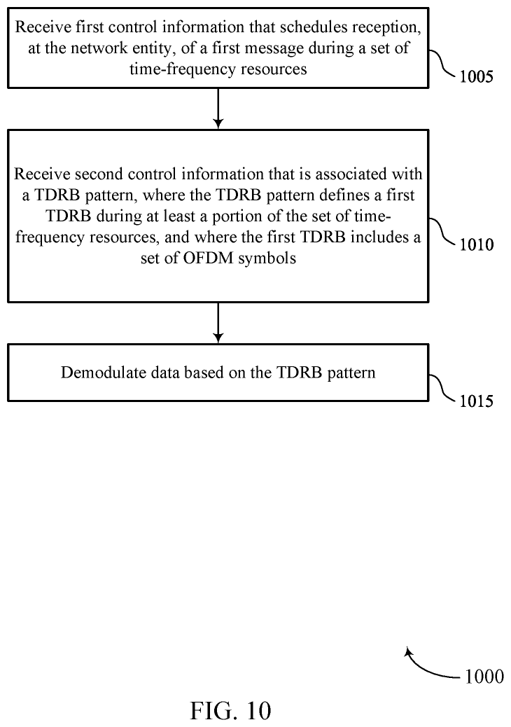

FIG. 10 shows a flowchart illustrating a method 1000 that supports TDRB mapping in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include receiving first control information that schedules reception, at the network entity, of a first message during a set of time-frequency resources. The operations of block 1005 may be performed in accordance with examples as disclosed herein. In some examples, aspects of the operations of 1005 may be performed by a scheduling component 825 as described with reference to FIG. 8.

At 1010, the method may include receiving second control information that is associated with a TDRB pattern, where the TDRB pattern defines a first TDRB during at least a portion of the set of time-frequency resources, and where the first TDRB includes a set of OFDM symbols. The operations of block 1010 may be performed in accordance with examples as disclosed herein. In some examples, aspects of the operations of 1010 may be performed by an TDRB pattern component 830 as described with reference to FIG. 8.

At 1015, the method may include demodulating data based on the TDRB pattern. The operations of block 1015 may be performed in accordance with examples as disclosed herein. In some examples, aspects of the operations of 1015 may be performed by a demodulation component 835 as described with reference to FIG. 8.

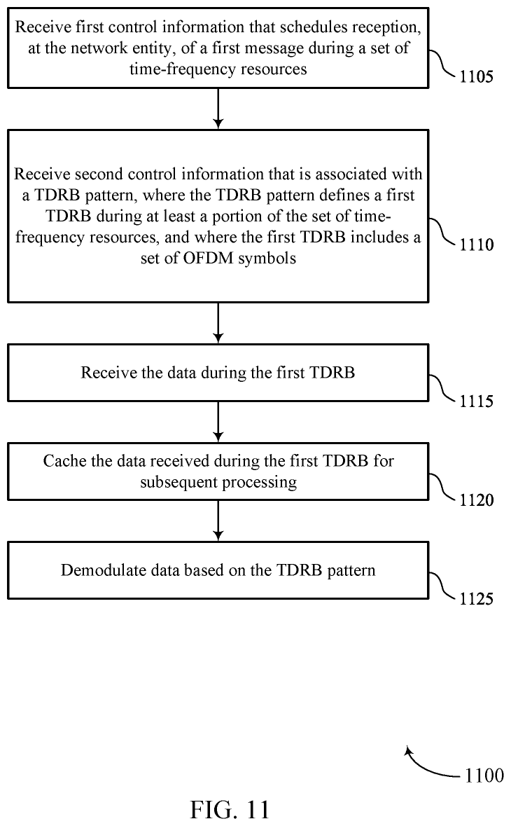

FIG. 11 shows a flowchart illustrating a method 1100 that supports TDRB mapping in accordance with one or more aspects of the present disclosure. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1105, the method may include receiving first control information that schedules reception, at the network entity, of a first message during a set of time-frequency resources. The operations of block 1105 may be performed in accordance with examples as disclosed herein. In some examples, aspects of the operations of 1105 may be performed by a scheduling component 825 as described with reference to FIG. 8.

At 1110, the method may include receiving second control information that is associated with a TDRB pattern, where the TDRB pattern defines a first TDRB during at least a portion of the set of time-frequency resources, and where the first TDRB includes a set of OFDM symbols. The operations of block 1110 may be performed in accordance with examples as disclosed herein. In some examples, aspects of the operations of 1110 may be performed by an TDRB pattern component 830 as described with reference to FIG. 8.

At 1115, the method may include receiving the data during the first TDRB. The operations of block 1115 may be performed in accordance with examples as disclosed herein. In some examples, aspects of the operations of 1115 may be performed by a data receiving component 840 as described with reference to FIG. 8.

At 1120, the method may include caching the data received during the first TDRB for subsequent processing. The operations of block 1120 may be performed in accordance with examples as disclosed herein. In some examples, aspects of the operations of 1120 may be performed by a caching component 845 as described with reference to FIG. 8.

At 1125, the method may include demodulating data based on the TDRB pattern. The operations of block 1125 may be performed in accordance with examples as disclosed herein. In some examples, aspects of the operations of 1125 may be performed by a demodulation component 835 as described with reference to FIG. 8.

The following provides an overview of aspects of the present disclosure:

Aspect 1: A method for wireless communication by a network entity, comprising: receiving first control information that schedules reception, at the network entity, of a first message during a set of time-frequency resources; receiving second control information that is associated with a TDRB pattern, wherein the TDRB pattern defines a first TDRB during at least a portion of the set of time-frequency resources, and wherein the first TDRB includes a set of OFDM symbols; and demodulating data based on the TDRB pattern.

Aspect 2: The method of aspect 1, further comprising: receiving the data during the first TDRB; and caching the data received during the first TDRB for subsequent processing.

Aspect 3: The method of any of aspects 1 through 2, wherein, to demodulate the data, the network entity is configured to demodulate the data after a temporally last OFDM symbol of the first TDRB.

Aspect 4: The method of any of aspects 1 through 3, further comprising: performing a channel estimation procedure after a temporally last OFDM symbol of the first TDRB, wherein the channel estimation procedure is based on a portion of the data received during the first TDRB.

Aspect 5: The method of any of aspects 1 through 4, wherein the TDRB pattern defines a plurality of TDRBs that includes the first TDRB, and wherein a codeword of the first message is resource mapped to the first TDRB in accordance with a mapping scheme on a per TDRB basis.

Aspect 6: The method of aspect 5, wherein the mapping scheme is a time-first, frequency-second mapping scheme within each of the plurality of TDRBs.

Aspect 7: The method of any of aspects 5 through 6, wherein the mapping scheme is a frequency-first, time-second mapping scheme within each of the plurality of TDRBs.

Aspect 8: The method of any of aspects 5 through 7, wherein the plurality of TDRBs includes one or more TDRBs in each of multiple subbands, and wherein the mapping scheme is a frequency-first, time-second mapping scheme within each of the plurality of TDRBs, and a subband-first, time-second mapping scheme between individual ones of the plurality of TDRBs.

Aspect 9: The method of any of aspects 1 through 8, wherein the TDRB pattern comprises the first TDRB and one or more second TDRBs that follow, in time, the first TDRB.

Aspect 10: The method of aspect 9, wherein the first TDRB includes one or more boundaries in time based on locations of DMRS symbols, wherein the one or more boundaries include at least one of a starting boundary in time or an ending boundary in time.

Aspect 11: The method of aspect 10, wherein the ending boundary is defined by a temporally last OFDM symbol of the first TDRB being a DMRS symbol.

Aspect 12: The method of any of aspects 10 through 11, wherein the starting boundary is defined by a temporally first OFDM symbol of the first TDRB being a DMRS symbol.

Aspect 13: The method of any of aspects 9 through 12, wherein the first TDRB and a temporally first of the one or more second TDRBs that immediately follows the first TDRB are defined by a DMRS symbol that is either a temporally last OFDM symbol of the first TDRB or a temporally first OFDM symbol of the temporally first of the one or more second TDRBs.

Aspect 14: The method of any of aspects 9 through 13, wherein at least one of the first TDRB or the one or more second TDRBs is defined to include a DMRS symbol that is a channel estimation source for one or more OFDM symbols in an adjacent TDRB of the one or more second TDRBs.

Aspect 15: The method of aspect 14, wherein the adjacent TDRB is one of a temporally first or last of the one or more second TDRBs.

Aspect 16: The method of any of aspects 9 through 15, wherein one or more temporally last TDRBs of the one or more second TDRBs do not include DMRSs.

Aspect 17: The method of aspect 16, wherein the one or more temporally last TDRBs each include only one OFDM symbol or less than a threshold quantity of OFDM symbols.

Aspect 18: The method of any of aspects 9 through 17, wherein at least one of the first TDRB and the one or more second TDRBs includes an ending boundary, in time, that aligns with a slot boundary.

Aspect 19: The method of any of aspects 1 through 18, wherein the second control information is indicative of a quantity of DMRSs or DMRS occasions per TDRB, a TDRB maximum duration, or a combination thereof.

Aspect 20: The method of any of aspects 1 through 19, wherein the second control information is indicative of the TDRB pattern.

Aspect 21: The method of any of aspects 1 through 20, wherein the second control information indicates that the network entity is to switch to or from application of the TDRB pattern.

Aspect 22: The method of any of aspects 1 through 21, wherein the second control information is received via an RRC message, a MAC-CE, a DCI message, or any combination thereof.

Aspect 23: The method of any of aspects 1 through 22, further comprising: reporting channel estimation time window duration information, wherein the second control information is based on the channel estimation time window duration information.

Aspect 24: The method of any of aspects 1 through 23, wherein the second control information includes a DMRS pattern or an updated TDRB pattern, or both, that is based on channel estimation time window duration information.

Aspect 25: A method for wireless communication by a first network entity, comprising: transmitting first control information that schedules reception, at a second network entity, of a first message during a set of time-frequency resources; transmitting second control information that is associated with a TDRB pattern, wherein the TDRB pattern defines a first TDRB during at least a portion of the set of time-frequency resources, and wherein the first TDRB includes a set of OFDM symbols.

Aspect 26: The method of aspect 25, wherein the TDRB pattern defines a plurality of TDRBs that includes the first TDRB, and wherein a codeword of the first message is resource mapped to the first TDRB in accordance with a mapping scheme on a per TDRB basis.

Aspect 27: The method of aspect 26, wherein the mapping scheme is a time-first, frequency-second mapping scheme within each of the plurality of TDRBs.

Aspect 28: The method of any of aspects 26 through 27, wherein the mapping scheme is a frequency-first, time-second mapping scheme within each of the plurality of TDRBs.

Aspect 29: The method of any of aspects 26 through 28, wherein the plurality of TDRBs includes one or more TDRBs in each of multiple subbands, and wherein the mapping scheme is a frequency-first, time-second mapping scheme within each of the plurality of TDRBs, and a subband-first, time-second mapping scheme between individual ones of the plurality of TDRBs.

Aspect 30: The method of any of aspects 25 through 29, wherein the TDRB pattern comprises the first TDRB and one or more second TDRBs that follow, in time, the first TDRB.

Aspect 31: The method of aspect 30, wherein the first TDRB includes one or more boundaries in time based on locations of DMRS symbols, wherein the one or more boundaries include at least one of a starting boundary in time or an ending boundary in time.

Aspect 32: The method of aspect 31, wherein the ending boundary is defined by a temporally last OFDM symbol of the first TDRB being a DMRS symbol.

Aspect 33: The method of any of aspects 31 through 32, wherein the starting boundary is defined by a temporally first OFDM symbol of the first TDRB being a DMRS symbol.

Aspect 34: The method of any of aspects 30 through 33, wherein the first TDRB and a temporally first of the one or more second TDRBs that immediately follows the first TDRB are defined by a DMRS symbol that is either a temporally last OFDM symbol of the first TDRB or a temporally first OFDM symbol of the temporally first of the one or more second TDRBs.

Aspect 35: The method of any of aspects 30 through 34, wherein at least one of the first TDRB or the one or more second TDRBs is defined to include a DMRS symbol that is a channel estimation source for one or more OFDM symbols in an adjacent TDRB of the one or more second TDRBs.

Aspect 36: The method of aspect 35, wherein the adjacent TDRB is one of a temporally first or last of the one or more second TDRBs.

Aspect 37: The method of any of aspects 30 through 36, wherein one or more temporally last TDRBs of the one or more second TDRBs do not include DMRSs.

Aspect 38: The method of aspect 37, wherein the one or more temporally last TDRBs each include only one OFDM symbol or less than a threshold quantity of OFDM symbols.

Aspect 39: The method of any of aspects 30 through 38, wherein at least one of the first TDRB and the one or more second TDRBs includes an ending boundary, in time, that aligns with a slot boundary.

Aspect 40: The method of any of aspects 25 through 39, wherein the second control information is indicative of a quantity of DMRSs or DMRS occasions per TDRB, a TDRB maximum duration, or a combination thereof.

Aspect 41: The method of any of aspects 25 through 40, wherein the second control information is indicative of the TDRB pattern.

Aspect 42: The method of any of aspects 25 through 41, wherein the second control information indicates that the second network entity is to switch to or from application of the TDRB pattern.

Aspect 43: The method of any of aspects 25 through 42, wherein the second control information is transmitted via an RRC message, a MAC-CE, a DCI message, or any combination thereof.

Aspect 44: The method of any of aspects 25 through 43, further comprising: receiving a report comprising channel estimation time window duration information, wherein the second control information is based on the channel estimation time window duration information.

Aspect 45: The method of any of aspects 25 through 44, wherein the second control information includes a DMRS pattern or an updated TDRB pattern, or both, that is based on channel estimation time window duration information.

Aspect 46: A network entity for wireless communication, comprising a processing configured to perform a method of any of aspects 1 through 24.

Aspect 47: A network entity for wireless communication, comprising at least one means for performing a method of any of aspects 1 through 24.

Aspect 48: A non-transitory computer-readable medium storing code for wireless communication, the code comprising instructions executable by one or more processors to perform a method of any of aspects 1 through 24.

Aspect 49: A first network entity for wireless communication, comprising one or more memories storing processor-executable code, and one or more processors coupled with the one or more memories and individually or collectively operable to execute the code to cause the first network entity to perform a method of any of aspects 25 through 45.

Aspect 50: A first network entity for wireless communication, comprising at least one means for performing a method of any of aspects 25 through 45.

Aspect 51: A non-transitory computer-readable medium having code for wireless communication stored thereon that, when executed by a network entity, causes the network entity to perform a method of any of aspects 25 through 45.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive first control information that schedules reception, at the network entity, of a first message during a set of time-frequency resources;
receive second control information that is associated with a time-domain resource block pattern, wherein the time-domain resource block pattern defines a first time-domain resource block during at least a portion of the set of time-frequency resources, and wherein the first time-domain resource block includes a set of orthogonal frequency-division multiplexing (OFDM) symbols; and
demodulate data based on the time-domain resource block pattern.

2. The network entity of claim 1, wherein the processing system is configured to:
receive the data during the first time-domain resource block; and
cache the data received during the first time-domain resource block for subsequent processing.

3. The network entity of claim 1, wherein, to demodulate the data, the processing system is configured to demodulate the data after a temporally last OFDM symbol of the first time-domain resource block.

4. The network entity of claim 1, wherein the processing system is configured to:
perform a channel estimation procedure after a temporally last OFDM symbol of the first time-domain resource block, wherein the channel estimation procedure is based on a portion of the data received during the first time-domain resource block.

5. The network entity of claim 1, wherein the time-domain resource block pattern defines a plurality of time-domain resource blocks that includes the first time-domain resource block, and wherein a codeword of the first message is resource mapped to the first time-domain resource block in accordance with a mapping scheme on a per time-domain resource block basis.

6. The network entity of claim 5, wherein the mapping scheme is a time-first, frequency-second mapping scheme within each of the plurality of time-domain resource blocks.

7. The network entity of claim 5, wherein the mapping scheme is a frequency-first, time-second mapping scheme within each of the plurality of time-domain resource blocks.

8. The network entity of claim 5, wherein the plurality of time-domain resource blocks includes one or more time-domain resource blocks in each of multiple subbands, and wherein the mapping scheme is a frequency-first, time-second mapping scheme within each of the plurality of time-domain resource blocks, and a subband-first, time-second mapping scheme between individual ones of the plurality of time-domain resource blocks.

9. The network entity of claim 1, wherein the time-domain resource block pattern comprises the first time-domain resource block and one or more second time-domain resource blocks that follow, in time, the first time-domain resource block.

10. The network entity of claim 9, wherein the first time-domain resource block includes one or more boundaries in time based on locations of demodulation reference signal (DMRS) symbols, wherein the one or more boundaries include at least one of a starting boundary in time or an ending boundary in time.

11. The network entity of claim 10, wherein the ending boundary is defined by a temporally last OFDM symbol of the first time-domain resource block being a DMRS symbol.

12. The network entity of claim 10, wherein the starting boundary is defined by a temporally first OFDM symbol of the first time-domain resource block being a DMRS symbol.

13. The network entity of claim 9, wherein the first time-domain resource block and a temporally first of the one or more second time-domain resource blocks that immediately follows the first time-domain resource block are defined by a DMRS symbol that is either a temporally last OFDM symbol of the first time-domain resource block or a temporally first OFDM symbol of the temporally first of the one or more second time-domain resource blocks.

14. The network entity of claim 9, wherein at least one of the first time-domain resource block or the one or more second time-domain resource blocks is defined to include a DMRS symbol that is a channel estimation source for one or more OFDM symbols in an adjacent time-domain resource block of the one or more second time-domain resource blocks.

15. The network entity of claim 14, wherein the adjacent time-domain resource block is one of a temporally first or last of the one or more second time-domain resource blocks.

16. The network entity of claim 9, wherein one or more temporally last time-domain resource blocks of the one or more second time-domain resource blocks do not include demodulation reference signals (DMRSs).

17. The network entity of claim 16, wherein the one or more temporally last time-domain resource blocks each include only one OFDM symbol or less than a threshold quantity of OFDM symbols.

18. The network entity of claim 9, wherein at least one of the first time-domain resource block and the one or more second time-domain resource blocks includes an ending boundary, in time, that aligns with a slot boundary.

19. The network entity of claim 1, wherein the processing system is configured to:
report channel estimation time window duration information, wherein the second control information is based on the channel estimation time window duration information.

20. A first network entity for wireless communication, comprising:
a processing system configured to:
transmit first control information that schedules reception, at a second network entity, of a first message during a set of time-frequency resources; and
transmit second control information that is associated with a time-domain resource block pattern, wherein the time-domain resource block pattern defines a first time-domain resource block during at least a portion of the set of time-frequency resources, and wherein the first time-domain resource block includes a set of orthogonal frequency-division multiplexing (OFDM) symbols.

21. The first network entity of claim 20, wherein the second control information is indicative of a quantity of demodulation reference signals (DMRSs) or DMRS occasions per time-domain resource block, a time-domain resource block maximum duration, or a combination thereof.

22. The first network entity of claim 20, wherein the second control information is indicative of the time-domain resource block pattern.

23. The first network entity of claim 20, wherein the second control information indicates that the second network entity is to switch to or from application of the time-domain resource block pattern.

24. The first network entity of claim 20, wherein the second control information is transmitted via a radio resource control (RRC) message, a medium access control-control element (MAC-CE), a downlink control information (DCI) message, or any combination thereof.

25. The first network entity of claim 20, wherein the second control information includes a demodulation reference signal (DMRS) pattern or an updated time-domain resource block pattern, or both, that is based on channel estimation time window duration information.

26. A method for wireless communication by a network entity, comprising:
receiving first control information that schedules reception, at the network entity, of a first message during a set of time-frequency resources;
receiving second control information that is associated with a time-domain resource block pattern, wherein the time-domain resource block pattern defines a first time-domain resource block during at least a portion of the set of time-frequency resources, and wherein the first time-domain resource block includes a set of orthogonal frequency-division multiplexing (OFDM) symbols; and
demodulating data based on the time-domain resource block pattern.

27. The method of claim 26, further comprising:
receiving the data during the first time-domain resource block; and
caching the data received during the first time-domain resource block for subsequent processing.

28. The method of claim 26, wherein, to demodulate the data, the network entity is configured to demodulate the data after a temporally last OFDM symbol of the first time-domain resource block.

29. A method for wireless communication by a first network entity, comprising:
transmitting first control information that schedules reception, at a second network entity, of a first message during a set of time-frequency resources; and
transmitting second control information that is associated with a time-domain resource block pattern, wherein the time-domain resource block pattern defines a first time-domain resource block during at least a portion of the set of time-frequency resources, and wherein the first time-domain resource block includes a set of orthogonal frequency-division multiplexing (OFDM) symbols.

30. The method of claim 29, wherein the time-domain resource block pattern defines a plurality of time-domain resource blocks that includes the first time-domain resource block, and wherein a codeword of the first message is resource mapped to the first time-domain resource block in accordance with a mapping scheme on a per time-domain resource block basis.
